(19) United States
(12) Patent Application Publication
(10) Pub. No.: US 2026/0065718 A1
(43) Pub. Date: Mar. 5, 2026

(54) STRUCTURAL INTEGRITY MONITORING SYSTEM

(71) Applicant: Honda Motor Co., Ltd., Tokyo (JP)

(72) Inventor: Ryan J. Repka, Marysville, OH (US)

(21) Appl. No.: 18/825,474

(22) Filed: Sep. 5, 2024

(51) Int. Cl. G07C 5/00; G01M 17/007

(52) U.S. Cl. CPC G07C 5/006; G01M 17/007

(57) ABSTRACT

A structural integrity monitoring system for a vehicle having a vehicle body includes at least one sensor mounted to at least one location of the vehicle body to detect one or more parameters associated with a structural integrity of the vehicle body at the at least one location. The system also includes a display to show an information corresponding to the structural integrity of the vehicle body associated with the at least one location. Moreover, the system configured to determine a level of the structural integrity of the vehicle body at the least one location based on input from the at least one sensor. The controller is further configured to show, via the display, the level of the structure integrity at the at least one location and display the location of the at least one sensor.

### BACKGROUND

The disclosed subject matter relates generally to a vehicle. More particularly, the disclosed subject matter relates to a structural integrity monitoring system for a vehicle.

Generally, due to salt, moisture, and/or any other environmental conditions, the corrosion of vehicle body and its components, for example, underbody and frame starts. Such corrosion of the vehicle components is always measured by eye which provides just an estimate and generally differ from the actual condition by a large value.

### SUMMARY

In accordance with one embodiment of the present disclosure, a structural integrity monitoring system for a vehicle is provided. The vehicle has a vehicle body, and the structural integrity monitoring system includes at least one sensor configured to be mounted to at least one location of the vehicle body to detect one or more parameters associated with a structural integrity of the vehicle body at the at least one location. The structural integrity monitoring system also includes a display to show an information corresponding to the structural integrity of the vehicle body associated with the at least one location. Moreover, the structural integrity monitoring system includes a controller communicatively coupled to the at least one sensor and the display. The controller is configured to determine a level of the structural integrity of the vehicle body at the least one location based on input from the at least one sensor. The controller is further configured to show, via the display, the level of the structure integrity at the at least one location and display the location of the at least one sensor.

In accordance with another embodiment of the present disclosure, a vehicle is provided. The vehicle includes a vehicle body, and at least one sensor mounted to at least one location of the vehicle body to detect one or more parameters associated with a structural integrity of the vehicle body at the at least one location. The vehicle also includes a display to show an information corresponding to the structural integrity of the vehicle body associated with the at least one location. Moreover, the vehicle includes a controller communicatively coupled to the at least one sensor and the display. The controller is configured to determine a level of the structural integrity of the vehicle body at the least one location based on input from the at least one sensor. The controller is also configured and show, via the display, the level of the structure integrity at the at least one location and display the location of the at least one sensor.

In accordance with a further embodiment of the present disclosure a vehicle is provided. The vehicle includes a vehicle body, and a plurality of sensors mounted to a plurality of locations of the vehicle body to detect one or more parameters associated with a structural integrity of the vehicle body at each of the plurality of locations. The vehicle further includes a display to show an information corresponding to the structural integrity at each of the plurality of locations of vehicle body. Moreover, the vehicle includes a controller communicatively coupled to the plurality of sensors and the display. The controller is configured to determine a level of the structural integrity at each of the plurality of locations of the vehicle body based on input from the plurality of sensors. The controller is further configured to show, via the display, the level of the structure integrity at each of the plurality of locations of the vehicle body and display the location of the associated sensor. Moreover, the controller is configured to generate an alert in response to the level of structural integrity of the vehicle body at one or more of the plurality of locations falling below of a predetermined threshold level.

### BRIEF DESCRIPTION OF THE DRAWINGS

Certain embodiments of the present disclosure will be better understood from the following description taken in conjunction with the accompanying drawings in which:

FIG. 1 is a side perspective view of a vehicle, in accordance with one embodiment of the present disclosure; and

FIG. 2 is a block diagram of the vehicle of FIG. 1 schematically depicting various components of the vehicle, in accordance with one embodiment of the present disclosure.

### DETAILED DESCRIPTION OF EXEMPLARY EMBODIMENTS

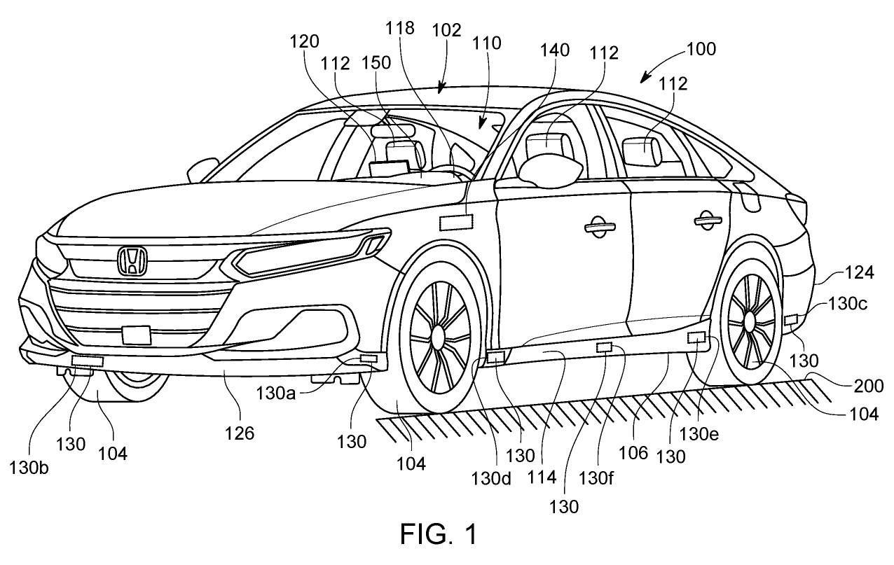

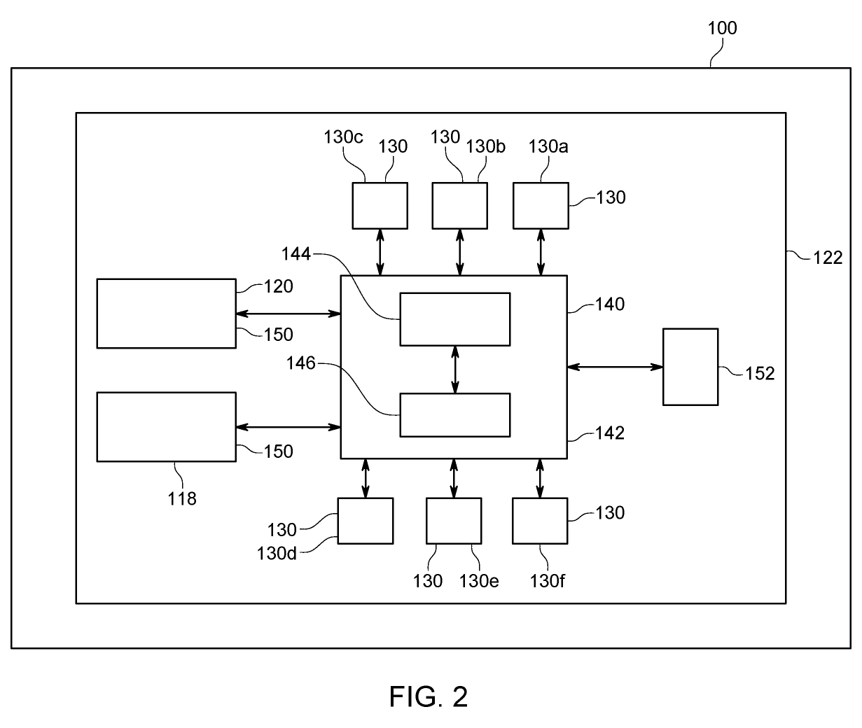

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-2, wherein like numbers indicate the same or corresponding elements throughout the views.

FIG. 1 illustrates a side perspective view of a vehicle, indicated generally at 100, in accordance with one embodiment of the present disclosure. The vehicle 100 is shown as a sedan. However, vehicle 100 in accordance with alternative embodiments can comprise any variety of vehicles, including trucks, vans, recreational vehicles, utility vehicles, agricultural equipment, or construction equipment, for example. The vehicle 100 includes a vehicle body 102 to which various components of the vehicle 100 are mounted, and a plurality of traction members 104, for example, wheels 104, movably supporting the vehicle body 102 on a ground surface 200. It may be appreciated that the vehicle body 102 includes an underbody frame 106 arranged facing the ground surface 200.

Further, the vehicle body 102 defines a passenger compartment 110 to facilitate a seating of one or more passenger including a driver inside the vehicle 100. To facilitate the seating of the one or more passengers inside the passenger compartment 110, the vehicle 100 includes one or more seats 112 arranged inside the passenger compartment 110 and supported on a floor 114 of the vehicle body 102. Moreover, the vehicle 100 includes a dashboard panel 118, for example, an instrument panel 118, that displays and/or provides one or more information related to the vehicle 100, for example, a speed and/or a torque of the vehicle 100. Moreover, the vehicle 100 includes an infotainment panel 120 that facilitates a display and control of a variety of vehicle information and the functions. In some embodiments, the infotainment panel 120 may be connected to and/or communicatively coupled to various vehicle sensors, for example, rear camera to display a view at a rear of the vehicle during reversing and a navigation module to display a path from one location to another location. It may be appreciated that the infotainment panel 120 may be connected or communicatively coupled to any other system or component of the vehicle and is not limited to the system or components described herein.

Further, the vehicle 100 includes a structural integrity monitoring system 122 (shown in FIG. 2), hereinafter simply referred to as system 122, configured to monitor and display structural integrity at one or more locations of the vehicle body 102. For example, the system 122 may monitor structural integrity of one or more components of the vehicle body 102, for example, the underbody frame 106, an axle, a front bumper 126, a rear bumper 124, or any other component or location of the vehicle 100. The system 122 may monitor structural integrity at various locations of a single component for example, a front portion, a rear portion, a middle portion of the underbody frame 106. To facilitate the monitoring of the structural integrity at various locations of the vehicle body 102, the system 122 includes at least one sensor 130 mounted on one or more locations, also referred to as monitored locations, of the vehicle body 102 at which the structural integrity is to be monitored.

In the illustrated embodiment, the system 122 includes six sensors 130 coupled to the vehicle body 102 at six different locations. As shown, two sensors 130a, 130b are arranged and mounted on left and right sides of the front bumper 122 to monitor structural integrity of the front bumper 126, while one sensor 130c is arranged and mounted to the rear bumper 124. Moreover, three sensors 130d, 130e, 130f are mounted on different locations of the underbody frame 106. As shown, the sensor 130d is mounted to the underbody frame 106 at a location proximate to the front wheels 104 and rear of the front wheels 104, while the sensor 130e is mounted to the underbody frame 106 at a location proximate to the rear wheels 104 and front of the rear wheels 104. Further, the sensor 130f is arranged substantially centrally to underbody frame 106 of the vehicle body 102. It may be appreciated that the system 122 may include additional sensors mounted at other locations at which the structural integrity of the vehicle body 102 is to be monitored. Also, the system 122 may include a smaller number of sensors 130 to monitor the structural integrity at fewer locations of the vehicle body 102. Moreover, sensors 130 may be mounted at any desired locations and the scope of the disclosure is not limited by the locations shown and discussed herein.

In some embodiments, each of the sensors 130a, 130b, 130c, 130d, 130e, 130f (collectively referred by reference numeral 130) is adapted to monitor/detect/determine one or more parameters that facilitates a determination of a level of structural integrity at the location of the associated sensor 130.

In an embodiment, one or more parameters includes an extent of rusting or corrosion at the location of the sensor 130. In some embodiments, the one or more parameters may include remaining thickness of the component at the location of the sensor 130, a remaining weight of the component, an amount of rust, etc. In some embodiments, the one or more parameters may include electrical resistance, magnetic property, for example, magnetic flux, or any other similar electrical or magnetic property of the material, known in the art, and adapted to be measured by the sensor 130 to determine the extent of corrosion at the site/location of the sensor 130 and thereby the level of structural integrity at the location of the sensor 130. In some embodiments, the sensor 130 may be electrical resistance sensor, electrochemical sensor, ultrasonic sensor, magnetic flux leakage sensor, multi-frequency electromagnetic sensor, acoustic sensor, or any other suitable sensor, known in the art, that facilitates monitoring of level of corrosion and/or determination of structural damage due to corrosion.

It may be appreciated that the information i.e., one or more parameters, determined by each sensor 130 facilitates in determination of a remaining percentage of structural integrity, i.e., a current structural integrity level of the vehicle body 102 and its component arranged at the location associated with the sensor 130 with respect to an initial structural integrity level when the vehicle body 102 is new or recently repaired and/or the structural integrity. In some embodiments, the initial structural integrity level is at one hundred percent level. However, the initial structural integrity level may be set at any other value than the one hundred percent level.

Further, the system 122 includes a controller 140 communicatively coupled to each of the sensors 130 to receive the information or data from the sensors 130 and to determine the structural integrity level at each of the locations, associated with the sensors 130, of the vehicle body 102. In some embodiments, the controller 140 may be an electronic control module (ECM) 142 of the vehicle 100. As shown, the controller 140 includes a processor 144 and a memory 146 to respectively process and store the data received from the at sensors 130 and other electrical and electronic component of the vehicle 100. In some embodiments, the instructions to process the data received from each sensor 130 is stored inside the memory 146 of the controller 140.

The memory 146 may be integrated into the controller 140, but those skilled in the art will understand that the memory 146 may be separate from the controller 140 but onboard the vehicle 100, and/or remote from the controller 140 and the vehicle 100, while still being associated with and accessible by the controller 140 to store information in and retrieve information from the memory 146 as necessary. In an embodiment, the memory 146 stores information related to the locations of the sensors 130 and the processor 144 associates the structural integrity level corresponding to each of the sensors 130 with the location of the sensors 130 on the vehicle body 102. It may be appreciated that the locations of the sensors 130 are added to the memory 146 at the installation of the sensors 130 to the vehicle body 102 and/or configuring the sensors 130 with the system 122 i.e., processor 144 for the vehicle 100. Although the processor 144 is contemplated, it is also possible and contemplated to use other electronic components such as a microcontroller, an application specific integrated circuit (ASIC) chip, or any other integrated circuit device. The processor 144 is configured to execute specified instructions, which controls and monitors various functions associated with sensors 130 and/or any other component of the vehicle 100.

Further, the system 122 includes a display 150 arranged inside the passenger compartment 110 and configured to display/illustrate/show/indicate the structural integrity level of each of the locations of the vehicle body at which the sensors 130 are mounted. Moreover, the display 150 is arranged and configured to display locations of the sensors while displaying the structural integrity level. In some embodiments, the processor 144 communicates with the display 150 show the structural integrity level at each location of the sensors 130 as a horizontal or vertical bar showing a percentage of structural integrity remaining at each monitored location of the vehicle body 102 relative to an initial level of the structural integrity when the vehicle component is either new or repaired. The processor 144 may determine and display the structural integrity level constantly, periodically, or intermittently.

In some embodiments, the display 150 may include the dashboard panel 118, for example, instrument panel 118, of the vehicle 100. In some embodiments, the display 150 may be the infotainment panel 120 of the vehicle 100. It may be appreciated that the display 150 may enable a selection, by a user, to view the structural at each of the monitored locations of the vehicle body 102 independently and exclusively of other monitoring locations. In some embodiments, the display 150 provides a scroll down menu to choose one monitored location out of the plurality of monitored locations at, and the processor 144, via the display 150, displays/shows the structural integrity level at the chosen/selected location. In some embodiments, the display 150 and the processor 144 are configured to display/show the structural integrity level associated with the monitored locations simultaneously on a single display window and display the location associated with each displayed bar.

Further, the processor 144 is configured to generate an alarm when the structural integrity level at one or more of the monitored locations (locations at which the sensors 130 are mounted) falls below a predetermined threshold level. In some embodiments, the predetermined threshold level may vary from one monitored location to another monitored location. In some embodiments, the predetermined threshold level may be identical for each of the monitored locations. It may be appreciated that the predetermined threshold level corresponding to each of the monitored locations is stored inside the memory 146 and is arranged to be easily accessed by the processor 144.

Moreover, the alarm may be a visual alarm, an audio alarm, or a notification. In some embodiments, the processor 144 displays the notification on the infotainment panel 120 and/or the dashboard panel 118 of the vehicle 100. It may be appreciated that the notification may include an information about the remaining structural integrity level at the associated location of the vehicle body 102 as well as information about the location of the vehicle body 102 at which the structural integrity has fallen below the predetermined threshold level. For example, the notification may state that the structural integrity level at the middle portion of the underbody frame 106 has fallen below a thirty percent of the initial structural integrity level. Also, the notification may notify the user that it is now unsafe to drive or operate the vehicle 100 and may prompt the user to repair the vehicle 100 at the indicated location.

In some embodiments, the display 150, for example, the dashboard panel 118 and/or the infotainment panel 120, may include a light 152 and the processor 144, optionally, or additionally, may actuate the light 152 in response to the structural integrity level, at one or more of the monitored locations, has fallen below the predetermined threshold level. The illumination of the light 152 acts as a visual alarm for the driver of the vehicle 100. Additionally, or optionally, the processor 144 is configured to send the notification as a message to a smart phone of the user, for example, a driver or an owner, of the vehicle, informing the user that the structural integrity level at one or more of the monitored locations has fallen below the predetermined threshold level. The notification, sent over the smart phone, may also include the information or indication of each location at which structural integrity level has fallen below the associated predetermined threshold level.

It may be appreciated that the alarm, displayed by the display 150, remains active until a repair is performed or the old component is replaced with a new component. Also, a deactivation of the alarm, by the user, on the display 150 is inhibited and the alarm remains active even if the user of the vehicle 100 attempts to disable the alarm via the display 150. The alarm is reset upon performing the repair and/or replacement of the deteriorated component. In some embodiments, the alarm is automatically reset upon determination/detection of the structural integrity level of the vehicle body 102 at the associated location, and processor 144 resets and displays the structural integrity at the repaired location at the initial structural integrity level, for example, at hundred percent. In some embodiment, the alarm is reset by a technician after performing the necessary repair and/or replacing the component. In this manner, the system 122 provides necessary information about the structural integrity of the component and prevents the deterioration of the components, for example, frame of the vehicle 100, beyond a critical point. Also, the system 122 enables the necessary monitoring of the structural integrity of the vehicle body 102 and facilitates the user to perform necessary repair on the vehicle, increasing overall life span of the vehicle 100.

The foregoing description of embodiments and examples has been presented for purposes of illustration and description. It is not intended to be exhaustive or to limit the disclosure to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the disclosure is, of course, not limited to the examples or embodiments set forth herein, but can be employed in any number of applications and equivalent devices by those of ordinary skill in the art. Rather it is hereby intended that the scope of the disclosure be defined by the claims appended hereto.

What is claimed is:

1. A structural integrity monitoring system for a vehicle having a vehicle body, the structural integrity monitoring system comprising:
at least one sensor configured to be mounted to at least one location of the vehicle body to detect one or more parameters associated with a structural integrity of the vehicle body at the at least one location;
a display to show an information corresponding to the structural integrity of the vehicle body associated with the at least one location; and
a controller communicatively coupled to the at least one sensor and the display
and configured to
determine a level of the structural integrity of the vehicle body at the least one location based on input from the at least one sensor, and
show, via the display, the level of the structure integrity at the at least one location and display the location of the at least one sensor.

2. The structural integrity monitoring system of claim 1, wherein the controller is configured to generate an alert in response to the level of the structural integrity at the at least one location falls below a predetermined threshold level.

3. The structural integrity monitoring system of claim 2, wherein the alert is at least one of an audio alert, a visual alert, or a notification shared to a smartphone.

4. The structural integrity monitoring system of claim 2, wherein the alert is at least one a notification or a light displayed on the display.

5. The structural integrity monitoring system of claim 4, wherein the display includes at least one of a dashboard panel or an infotainment panel of the vehicle.

6. The structural integrity monitoring system of claim 5, wherein the alert remains active until a repair is performed at the one of more locations having the structural integrity level below the predetermined threshold level.

7. The structural integrity monitoring system of claim 1, wherein
the at least one sensor includes a plurality of sensors mounted at a plurality of locations of the vehicle body to monitor structural integrity at the plurality of locations, and
the controller is configured to
determine a level of structural integrity at each of the plurality of locations,
show, via the display, the level of structural integrity at each of the location along with the associated location, and
generate an alert in response to the level of structural integrity of the vehicle body at one or more of the plurality of locations falls below of a threshold level.

8. The structural integrity monitoring system of claim 7, wherein the predetermined threshold level varies based on components associated with plurality of locations.

9. A vehicle, comprising:
a vehicle body;
at least one sensor mounted to at least one location of the vehicle body to detect one or more parameters associated with a structural integrity of the vehicle body at the at least one location;
a display to show an information corresponding to the structural integrity of the vehicle body associated with the at least one location; and
a controller communicatively coupled to the at least one sensor and the display
and configured to
determine a level of the structural integrity of the vehicle body at the least one location based on input from the at least one sensor, and
show, via the display, the level of the structure integrity at the at least one location and display the location of the at least one sensor.

10. The vehicle of claim 9, wherein the controller is configured to generate an alert in response to the level of the structural integrity at the at least one location falls below a predetermined threshold level.

11. The vehicle of claim 10, wherein the alert is at least one of an audio alert, a visual alert, or a notification shared to a smartphone.

12. The vehicle of claim 10, wherein the alert is at least one of a notification or a light displayed on the display.

13. The vehicle of claim 12, wherein the display includes at least one of a dashboard panel or an infotainment panel of the vehicle.

14. The vehicle of claim 12, wherein the alert remains active until a repair is performed at the one of more locations having the structural integrity level below the predetermined threshold level.

15. The vehicle of claim 10, wherein
the at least one sensor includes a plurality of sensors mounted at a plurality of locations of the vehicle body to monitor structural integrity at the plurality of locations, and
the controller is configured to determine a level of structural integrity at each of the plurality of locations and show, via the display, the level of structural integrity at each of the location along with the associated location.

16. The vehicle of claim 15, wherein the controller is configured to generate an alert in response to the level of structural integrity of the vehicle body at one or more of the plurality of locations falls below of a predetermined threshold level.

17. The vehicle of claim 16, wherein the predetermined threshold level varies based on components associated with plurality of locations.

18. A vehicle, comprising:
a vehicle body;
a plurality of sensors mounted to a plurality of locations of the vehicle body to detect one or more parameters associated with a structural integrity of the vehicle body at each of the plurality of locations;
a display to show an information corresponding to the structural integrity at each of the plurality of locations of vehicle body; and
a controller communicatively coupled to the plurality of sensors and the display, the controller is configured to
determine a level of the structural integrity at each of the plurality of locations of the vehicle body based on input from the plurality of sensors,
show, via the display, the level of the structure integrity at each of the plurality of locations of the vehicle body and display the location of the associated sensor, and
generate an alert in response to the level of structural integrity of the vehicle body at one or more of the plurality of locations falling below of a predetermined threshold level.

19. The vehicle of claim 18, wherein the display includes at least one of a dashboard panel or an infotainment panel of the vehicle and the alert is at least one of a notification or a light shown on the display.

20. The vehicle of claim 19, wherein the alert remains active until a repair is performed at the one of more locations having the structural integrity level below the predetermined threshold level.
